(19) United States
(12) Patent Application Publication
(10) Pub. No.: US 2022/0075074 A1
(43) Pub. Date: Mar. 10, 2022

(54) OBSTACLE DETECTION DEVICE AND OBSTACLE DETECTION METHOD

(71) Applicant: DENSO CORPORATION, Kariya-city (JP)

(72) Inventors: Jian KANG, Nisshin-city (JP); Mitsutoshi MORINAGA, Kariya-city (JP)

(21) Appl. No.: 17/455,638

(22) Filed: Nov. 18, 2021

Related U.S. Application Data
(63) Continuation of application No. PCT/JP2020/019004, filed on May 12, 2020.

(30) Foreign Application Priority Data
May 20, 2019 (JP) 2019-094487

(51) Int. Cl. G01S 17/931; G01S 15/931; G01S 7/48

(52) U.S. Cl. CPC G01S 17/931; G01S 7/4808; G01S 15/931

(57) ABSTRACT

A result acquisition unit repeatedly acquires measurement results from an environment monitoring sensor that emits probe waves to a probe region and measures the distance and the direction to a reflection point at which the probe waves are reflected. A probability calculation unit calculates a detection probability for each reflection point in accordance with the measurement results acquired by the result acquisition unit. A type determination unit determines the type of the target having the reflection point in accordance with the detection probability calculated by the probability calculation unit.

### CROSS-REFERENCE TO THE RELATED APPLICATIONS

This application is the U.S. bypass application of International Application No. PCT/JP2020/019004 filed on May 12, 2020, which designated the U.S. and claims priority to Japanese Patent Application No. 2019-094487, filed May 20, 2019, the contents of both of these are incorporated herein by reference.

### BACKGROUND

### Technical Field

The present disclosure relates to a technique for detecting an obstacle.

### Description of the Related Art

A device used to detect an obstacle near a vehicle causes a sensor to transmit probe waves to the surroundings of the vehicle and receive the reflected waves from a target to detect the target. Targets are classified into small targets that can be driven over by vehicles and normal targets that cannot be driven over. For small targets, measures such as issuing an alarm may not be taken.

A technique is disclosed, which calculates the height of a target based on the emission angle of a beam from a sensor and the sensed distance to the target, and at a time when the target detected becomes undetectable, determines the target as a small target if the target detected previously has a height equal to or less than a threshold.

### SUMMARY

An aspect of the present disclosure provides an obstacle detection device including a result acquisition unit, a probability calculation unit, and a type determination unit. The result acquisition unit is configured to repeatedly acquire measurement results from an environment monitoring sensor that emits probe waves to a predetermined probe region and measures the distance and the direction to a reflection point at which the probe waves are reflected. The probability calculation unit is configured to calculate a detection probability for each reflection point in accordance with the measurement results acquired by the result acquisition unit. The type determination unit is configured to determine the type of the target having the reflection point in accordance with the detection probability calculated by the probability calculation unit.

### BRIEF DESCRIPTION OF THE DRAWINGS

In the accompanying drawings:

FIG. 1 is a block diagram showing the configuration of an obstacle detection device according to a first embodiment;

FIG. 2 is a diagram illustrating the installation position of an environment monitoring sensor;

FIG. 3 is a flowchart of a grid map update process;

FIG. 4 is a diagram illustrating a grid map update;

FIG. 5 is a diagram illustrating the data format of target information stored in a storage unit;

FIG. 6 is a flowchart of an obstacle detection process;

FIG. 7 is a flowchart of a type determination process;

FIG. 8 is a graph set illustrating changes over time in the detection probabilities of a normal target, a small target, and a virtual image;

FIG. 9 is a flowchart of a position determination process;

FIG. 10 is a diagram illustrating processing in the position determination process;

FIG. 11 is a diagram illustrating an installation position of an environment monitoring sensor 2 specific to the detection of a small target positioned above, and another installation position specific to the detection of a small target positioned below;

FIG. 12 is a block diagram showing the configuration of an obstacle detection device according to a second embodiment;

FIG. 13 is a diagram illustrating the installation positions of environment monitoring sensors;

FIG. 14 is a graph showing the results of measurements of the relationship between the detection probability and angles and distances indicating the relative positions of the environment monitoring sensors and a target;

FIG. 15 is a diagram illustrating parameters used in a position determination process;

FIG. 16 is a flowchart of the position determination process; and

FIG. 17 is a diagram illustrating the relationship between parameters M, m and measurement cycles and determination times.

### DETAILED DESCRIPTION OF THE PREFERRED EMBODIMENTS

A device used to detect an obstacle near a vehicle causes a sensor to send probe waves to the surroundings of the vehicle and receive the reflected waves from a target to detect the target. Targets are classified into small targets that can be driven over by vehicles and normal targets that cannot be driven over. For small targets, measures such as issuing an alarm may not be taken.

For example, a patent literature, JP 2009-181471 A discloses a technique that calculates the height of a target based on the emission angle of a beam from a sensor and the sensed distance to the target, and at a time when the target detected becomes undetectable, determines the target as a small target if the target detected previously has a height equal to or less than a threshold.

Specifically, the technique is based on the fact that the strength of reflection from a small target located away from the center of a beam changes greatly as the vehicle moves because a beam from a sensor decreases in signal strength with increasing separation from the center of the beam.

However, detailed research carried out by the present inventors has revealed that the known technique described in the above-described patent literature has the problem below. Specifically, in the known technique, the target to be determined needs to be detected continuously in order to find the time when the target becomes undetectable. However, a small target such as a parking block is typically low in signal strength and cannot be detected stably by the sensor. Such a target is thus difficult to detect continuously, that is, track in a stable manner. Moreover, such a weak signal cannot easily allow accurate detection of the distance to the target. As a result, the known technique cannot reliably determine whether a target is a small target.

In light of the above-described circumstances, with reference to the drawings, embodiments of the present disclosure will be described.

### 1. First Embodiment

### 1-1. Configuration

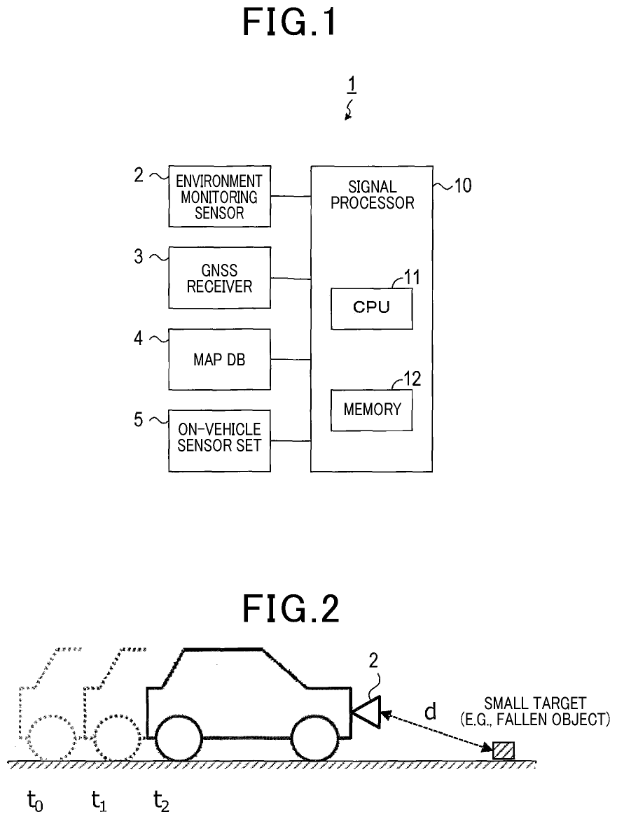

An obstacle detection device 1 shown in FIG. 1 is installed in a vehicle and detects a variety of obstacles located near the vehicle. The obstacle detection device 1 includes a signal processor 10. The obstacle detection device 1 may include an environment monitoring sensor 2, a GNSS receiver 3, a map database 4, and an on-vehicle sensor set 5. Hereinafter, the vehicle incorporating the obstacle detection device 1 will be referred to as the device-equipped vehicle.

The environment monitoring sensor 2 includes a laser radar or a millimeter-wave radar. For example, as shown in FIG. 2, the environment monitoring sensor 2 is installed in or near the front bumper of the device-equipped vehicle, and has a probe region that is a predetermined angle defined in a horizontal plane with the forward direction of the device-equipped vehicle as its center. Note that the environment monitoring sensor 2 may be installed in other position such as near the rearview mirror. The environment monitoring sensor 2 may also be installed in a manner to have a probe region that is rearward or sideward from the vehicle.

The environment monitoring sensor 2 scans each unit angle of the probe region in a horizontal direction, and calculates the distance to probe waves reflection point based on the travel time taken from the emission of the probe waves to the reception of the reflected waves from an object to which the probe waves are emitted. The environment monitoring sensor 2 performs a scan at every predetermined measurement cycle, and uses a scan angle and the distance calculated at the scan angle to generate reflection point information representing the position of the reflection point in a relative coordinate system with the installation position of the environment monitoring sensor 2 as its origin point.

The GNSS receiver 3 receives radio waves transmitted from artificial satellites for a GNSS, and generates vehicle positional information representing the position of the device-equipped vehicle in an absolute coordinate system that uses latitude and longitude. GNSS is an abbreviation for Global Navigation Satellite System.

The map database 4 is a storage that stores map data represented in an absolute coordinate system. The map data is expressed by nodes set at intersections between actual roads and links that connect nodes. Each node is associated with positional information as well as attribute information including the road width and the number of traffic lanes.

The on-vehicle sensor set 5 includes a speed sensor, a yaw rate sensor, and a steering angle sensor, and detects physical quantities related to the behavior of the vehicle.

The signal processor 10 includes a microcomputer provided with a CPU 11 and semiconductor memory (hereinafter, a memory 12) such as RAM, ROM, and flash memory. The signal processor 10 executes the processing of at least a grid map update process and an obstacle detection process.

The memory 12 stores programs for the grid map update process and the obstacle detection process, and has a storage area for target information and a storage area for a grid map.

### 1-2. Processing

The processing executed by the signal processor 10 will now be described.

### [1-2-1. Grid Map Update Process]

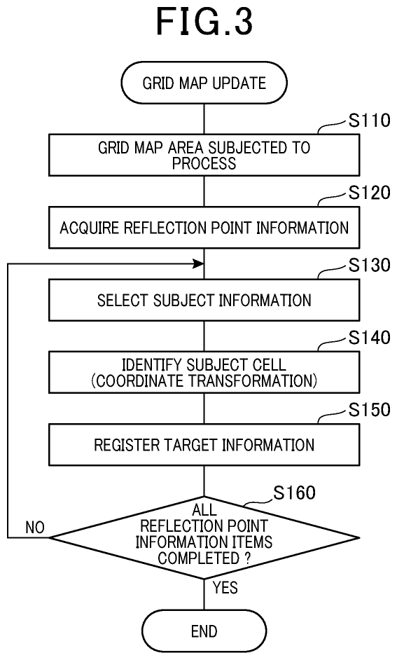

The grid map update process will now be described with reference to the flowchart shown in FIG. 3. The grid map update process is started at each measurement cycle. The measurement cycle is a period for the environment monitoring sensor 2 to scan the probe region.

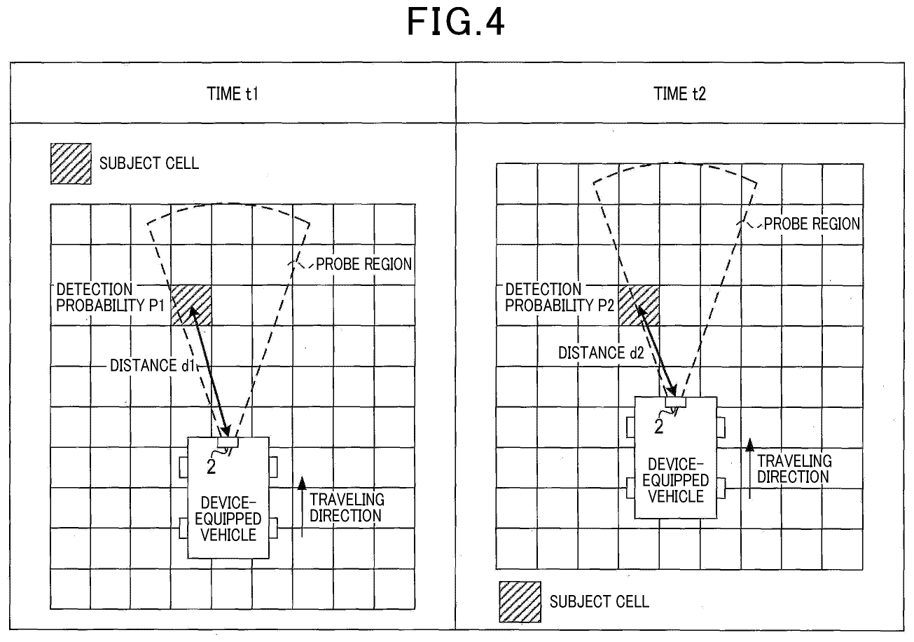

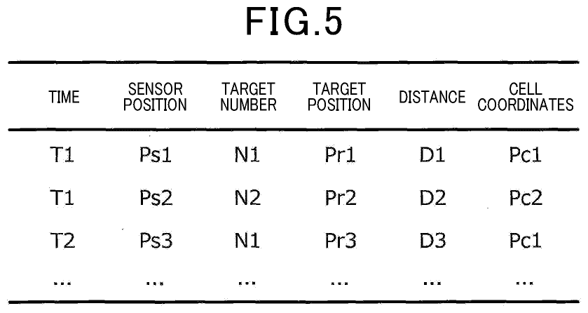

In S110, the signal processor 10 obtains the present position and the traveling direction of the device-equipped vehicle from the GNSS receiver 3, and in accordance with the obtained information, updates the grid map area subjected to the process. The grid map includes cells defined by a grid dividing the map into equally sized sections expressed in an absolute coordinate system. Each cell is given an identification number that identifies the cell. As shown in FIG. 4, the signal processor 10 updates the grid map area subjected to the process in a manner to include at least cells corresponding to the probe region of the environment monitoring sensor 2 with reference to the present position of the device-equipped vehicle. It is noted that the grid map uses the absolute coordinate system, and thus the position of each cell remains unchanged as the vehicle moves.

Referring back to FIG. 3, subsequently in S120, the signal processor 10 obtains, from the environment monitoring sensor 2, reflection point information indicating the results of scanning the probe region.

Subsequently in S130, the signal processor 10 selects, from the reflection point information obtained from the environment monitoring sensor 2, one reflection point information item yet to undergo the processing of S140 to S150 described below, as subject information.

Subsequently in S140, the signal processor 10 transforms the subject information represented in relative coordinates into absolute coordinates, and identifies the grid map cell corresponding to the position represented by the subject information (hereinafter, the subject cell).

Subsequently in S150, the signal processor 10 associates the subject information with the subject cell and stores the resultant information into the memory 12 as target information. The target information stored in the memory 12, as shown in FIG. 5, includes “Time,” “Sensor Position,” “Target Number,”, “Target Position”, “Distance,” and “Cell Coordinates.” “Time” indicates information identifying the measurement cycle at which the target information is stored. “Sensor Position” indicates the position of the environment monitoring sensor 2, and in this example, refers to the present position of the device-equipped vehicle obtained from the GNSS receiver 3. “Target Number” indicates information identifying each item of reflection point information generated in the environment monitoring sensor 2. “Target Position” indicates information representing the direction to the target indicated by the subject information. “Distance” indicates information representing the distance to the target indicated by the subject information. “Cell Coordinates” indicate information representing the absolute position of the subject cell identified in S140. The memory 12 manages target information stored for the past predetermined period of time, and items of information old and no longer needed are sequentially overwritten.

Subsequently in S160, the signal processor 10 determines whether all reflection point information items have undergone the processing of S140 to S150. If a reflection point information item is yet to undergo the processing, the signal processor 10 returns the processing to S130. If all the reflection point information items have undergone the processing, the signal processor 10 ends the grid map update process.

In this process, S110 corresponds to a position acquisition unit, and S120 corresponds to a result acquisition unit.

### [1-2-2. Obstacle Detection Process]

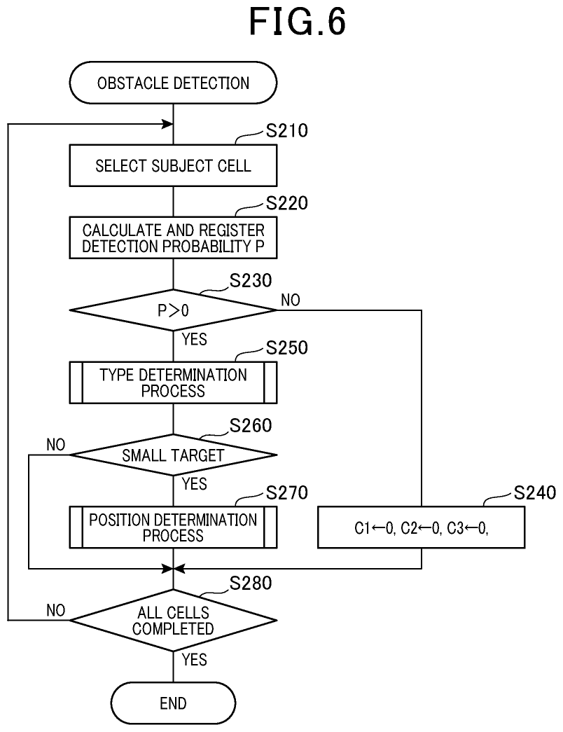

The obstacle detection process will now be described with reference to the flowchart shown in FIG. 6.

The processing of the obstacle detection process is carried out at each predetermined determination time. For example, assume that M is a positive integer, m=1 to M, and a determination time comes at every m measurement cycles.

In S210, the signal processor 10 selects, from the latest grid map updated in the grid map update process, a subject cell to undergo the processing. In this process, the grid map cells corresponding to the probe region of the environment monitoring sensor 2 are subjected to the processing. However, this is not restrictive. The overall grid map updated in S110 may be subjected to the processing.

Subsequently in S220, the signal processor 10 calculates a detection probability P=N/M, where N denotes the number of target information items regarding the subject cell that have been recorded in the memory 12 during the last M measurement cycles, and stores the calculated detection probability P into the memory 12. Note that the memory 12 stores, for each cell, detection probabilities P calculated at the last X determination times. X is an integer greater than or equal to two. Specifically, as shown in FIG. 17, if m=1, a determination time comes at every measurement cycle, and detection probabilities P are calculated at periods that overlap each other. If m=M, a determination time comes at every M measurement cycles, and detection probabilities P are calculated at periods that do not overlap.

Subsequently in S230, the signal processor 10 determines whether the detection probability P calculated in S220 is greater than zero. If P>0, the signal processor 10 advances the processing to S250. If P=0, the signal processor 10 advances the processing to S240.

In S240, the signal processor 10 resets, to 0, count values C1, C2, and C3 associated with the subject cell and used in the processing of S250 and S270 described below, and advances the processing to S280.

In S250, the signal processor 10 executes the processing of a type determination process for determining the type of the target in the subject cell using the detection probabilities P for the subject cell recorded in the memory 12. In the type determination process, the type of the target is determined as a normal target, a small target, or a virtual image. Normal targets are targets that cannot be driven over by vehicles. Small targets are targets that are smaller than normal targets in vertical size and can be driven over by vehicles.

Subsequently in S260, the signal processor 10 determines whether the determination result from the type determination process is a small target. If the determination result is a small target, the signal processor 10 advances the processing to S270. If the determination result is not a small target, the signal processor 10 advances the processing to S280.

In S270, the signal processor 10 executes the processing of a position determination process for determining the vertical position of the small target using the detection probabilities P for the subject cell recorded in the memory 12, and advances the processing to S280.

In S280, the signal processor 10 determines whether the processing of S220 to S270 has been executed for all the cells subjected to the process. If determining that a cell is yet to undergo the processing, the signal processor 10 returns the processing to S210. If determining that all the cells have undergone the processing, the signal processor 10 ends the process.

In this process, S220 corresponds to a probability calculation unit, and S250 corresponds to a type determination unit.

### [1-2-3. Type Determination Process]

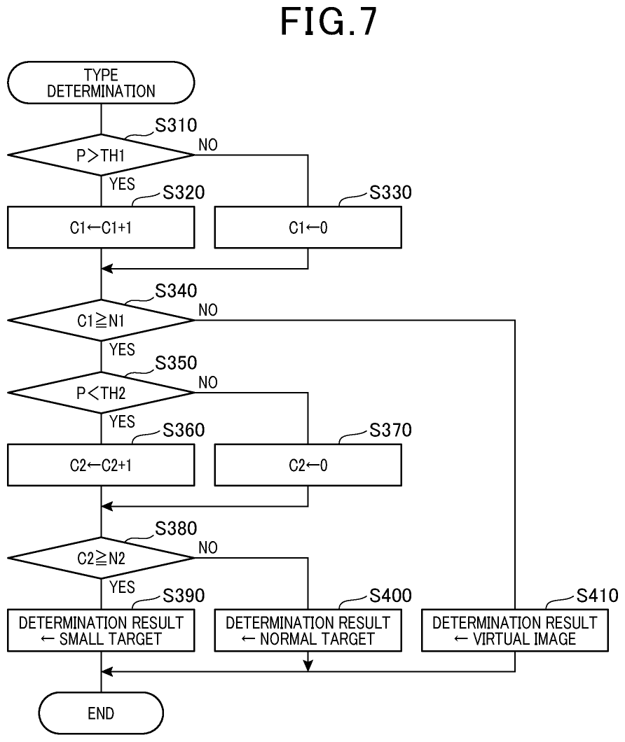

The processing of the type determination process executed in S250 by the signal processor 10 as described above will now be described with reference to the flowchart shown in FIG. 7.

In S310, the signal processor 10 determines whether the detection probability P calculated for the subject cell in S220 as described above is greater than a predetermined first threshold TH1. If determining that P>TH1, the signal processor 10 advances the processing to S320. If determining that P<=TH1, the signal processor 10 advances the processing to S330.

In S320, the signal processor 10 increments the count value C1 representing the number of times it is consecutively determined that P>TH1, and advances the processing to S340.

In S330, the signal processor 10 resets the count value C1 to 0 and advances the processing to S340.

In S340, the signal processor 10 determines whether the count value C1 is greater than or equal to a predetermined threshold N1. If determining that C1>=N1, or in other words, determining that P>TH1 at all the past N1 determination times, the signal processor 10 advances the processing to S350. If determining that C1<N1, the signal processor 10 advances the processing to S410.

In S350, the signal processor 10 determines whether the detection probability P recorded for the subject cell is smaller than a predetermined second threshold TH2. If determining that P<TH2, the signal processor 10 advances the processing to S360. If determining that P>=TH2, the signal processor 10 advances the processing to S370. Note that the second threshold TH2 is set at a value greater than the first threshold TH1.

In S360, the signal processor 10 increments the count value C2 representing the number of times it is consecutively determined that P<TH2, and advances the processing to S380.

In S370, the signal processor 10 resets the count value C2 to 0 and advances the processing to S370.

In S380, the signal processor 10 determines whether the count value C2 is greater than or equal to a predetermined threshold N2. If determining that C2>=N2, or in other words, determining that P>TH2 at all the past N2 determination times, the signal processor 10 advances the processing to S390. If determining that C2<N2, the signal processor 10 advances the processing to S400. Note that the thresholds N1 and N2 may be the same value or different values.

In S390, the signal processor 10 outputs the determination result that the target type is a small target, and ends the process. Specifically, when the detection probability P is greater than TH1 and smaller than TH2 for a certain period of time, the target is determined as a small target.

In S400, the signal processor 10 outputs the determination result that the target type is a normal target, and ends the process. Specifically, when the state of P>=TH2 is detected intermittently or continuously, the target is determined as a normal target.

In S410, the signal processor 10 outputs the determination result that the target type is a virtual image, and ends the process. Specifically, when the state of P>TH1 is detected sporadically, the target is determined as a virtual image.

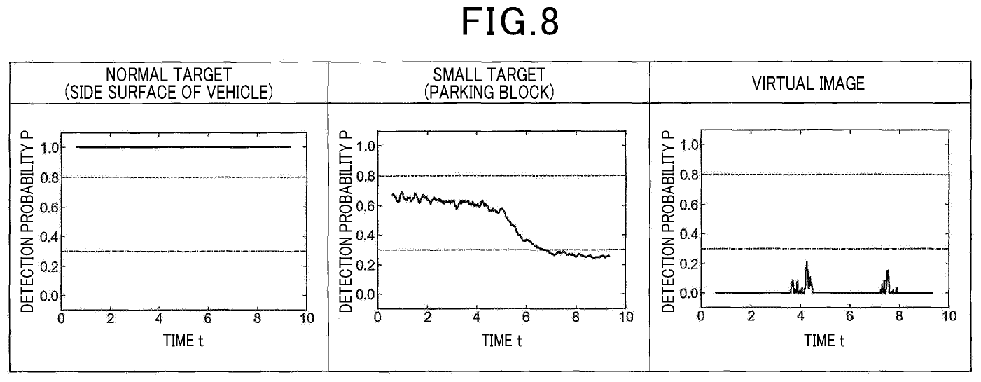

Specifically, as shown in FIG. 8, a normal target has a sufficiently large area for reflecting probe waves and produces strong reflected waves, and thus the detection probabilities P are approximately equal to 1. A virtual image is detected in a sudden and unexpected manner only when certain conditions are met, and thus the detection probabilities P within some duration of time are very small values. A small target, which is smaller than a normal target in area for reflecting probe waves, causes unstable detection, and thus the detection probabilities P are values between those of a normal target and a virtual image. Accordingly, the thresholds TH1 and TH2 may be set experimentally at values that enable these targets to be identified.

The graphs in FIG. 8 show changes over time in detection probabilities P calculated when a vehicle incorporating the environment monitoring sensor 2 approaches a normal target that is a side of a vehicle and a small target that is a parking block at a constant speed. Note that the results regarding a virtual image are obtained from measurement without a target.

### 2-3. Position Determination Process

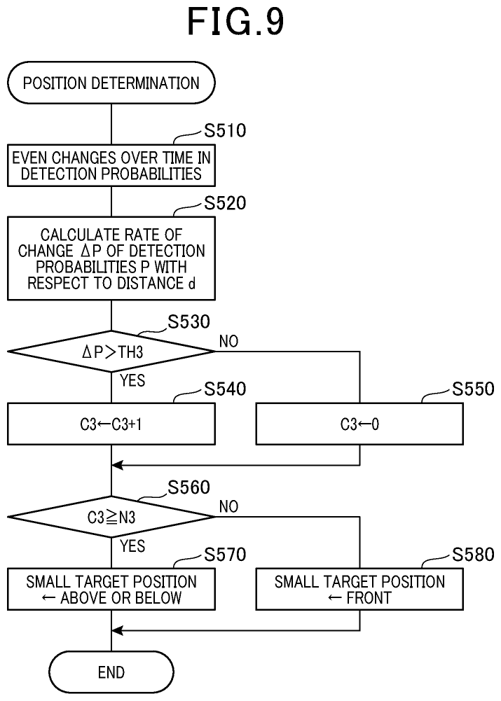

The processing of the position determination process executed in S270 by the signal processor 10 as described above will now be described with reference to the flowchart shown in FIG. 9.

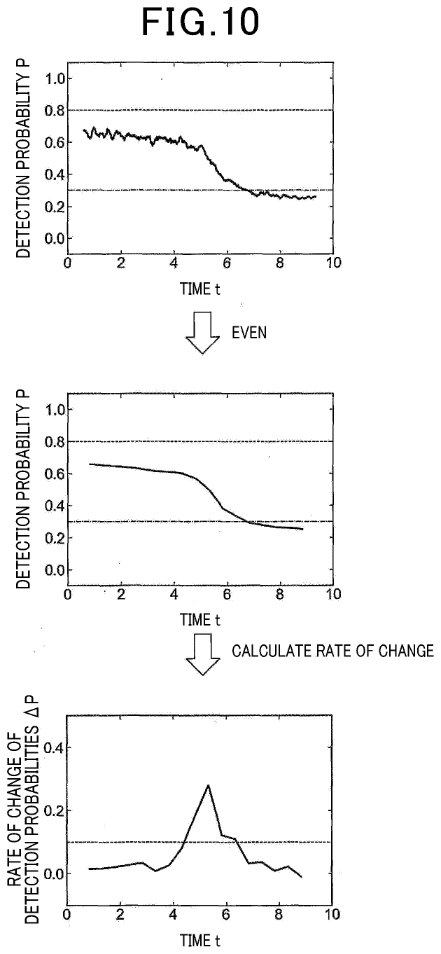

In S510, the signal processor 10 executes the processing of smoothing the changes over time in the detection probabilities P for the subject cell. This processing uses a low pass filter function. For example, the average value of the past several detection probabilities P may be calculated and used. As a result of the processing, the upper graph in FIG. 10 showing the changes over time in the detection probabilities P calculated at the determination times is transformed into the middle graph in FIG. 10 after smoothing.

Subsequently in S520, the signal processor 10 calculates the rate of change ΔP of detection probabilities P with respect to distance d. This is intended to obtain the rate of change ΔP that is a value dependent not on the moving speed of the device-equipped vehicle but on the distance to the target. As a result, the middle graph in FIG. 10 provides the lower graph in FIG. 10 showing the gradient in the middle graph. In this case, since the device-equipped vehicle moves at a constant speed, the time on the horizontal axis in each graph of FIG. 10 corresponds to the distance.

Subsequently in S530, the signal processor 10 determines whether the rate of change ΔP is greater than a predetermined third threshold TH3. If determining that ΔP>TH3, the signal processor 10 advances the processing to S540. If determining that ΔP<=TH3, the signal processor 10 advances the processing to S550.

In S540, the signal processor 10 increments the count value C3 representing the number of times it is consecutively determined that ΔP>TH3, and advances the processing to S560.

In S550, the signal processor 10 resets the count value C3 to 0 and advances the processing to S560.

In S560, the signal processor 10 determines whether the count value C3 is greater than or equal to a predetermined threshold N3. If determining that C3>=N3, or in other words, determining that ΔP>TH3 at all the past N3 determination times, the signal processor 10 advances the processing to S570. If determining that C3<N3, the signal processor 10 advances the processing to S580. Note that the threshold N3 may be the same value as the thresholds N1 and N2 or a different value.

In S570, the signal processor 10 outputs the determination result that the small target is positioned above or below, and ends the process.

In S580, the signal processor 10 outputs the determination result that the small target is positioned in front, and ends the process.

Specifically, when the small target is positioned in front of the environment monitoring sensor 2, that is, at the same height as the environment monitoring sensor 2, the small target is positioned continuously within the beam range irrespective of the distance to the environment monitoring sensor 2. Thus, the detection probability P does not vary greatly, and the rate of change ΔP remains at values near to 0. When the small target is positioned above or below the front of the environment monitoring sensor 2 and distant from the environment monitoring sensor 2, the entire small target is covered by the beam due to the spread of the beam and detected with detection probabilities Pin accordance with the distance. Also in this case, the rate of change ΔP of detection probabilities after smoothing remains at small values near to 0.

However, as the environment monitoring sensor 2 approaches the small target, the position of the small target within the beam becomes more distant from the center of the beam, and also the small target within the beam range decreases in covered area. As a result, the detection probability P changes greatly at or near a time when the small target crosses the beam boundary, increasing the rate of change ΔP of detection probabilities P. Then, after the entire small target goes out of the beam range, the detection probability P is stable at small values, and the rate of change ΔP remains at values near to 0. Specifically, the third threshold TH3 is set at a value that enables sensing of an increase in the rate of change ΔP occurring at or near a time when the small target crosses the boundary of the beam. Note that the boundary of the beam refers to a position having a signal strength 3 dB lower than the signal strength at the center of the beam. In this manner, the detection probability P has a characteristic change when the boundary of the beam is crossed, and the change is used to determine the vertical position of the small target in the boresight direction (i.e., the forward direction) of the environment monitoring sensor 2.

In this process, S520 corresponds to a change rate calculation unit, and S530 to S580 correspond to a height determination unit.

### 1-3. Effects

According to the first embodiment described in detail above, the following effects are achieved.

(1a) The obstacle detection device 1 determines the type of the target as one of a normal target, a small target, and a virtual image using target detection probabilities P instead of signal strengths received by the environment monitoring sensor 2.

Thus, the obstacle detection device 1 reduces the possibility that the detection is affected by environmental noise compared with detection that uses the received strengths, as well as improves the accuracy of detecting a small target that is difficult to track because of intermittent detection of reflection points.

(1b) The obstacle detection device 1 determines whether a target is a small target using the condition that the determination result of P>TH1 is detected at N1 or more consecutive determination times, and the determination result of P<TH2 is detected at N2 or more consecutive determination times. This reduces erroneous determination caused by a virtual image that occurs in a sudden and unexpected manner, thus further improving the reliability of the type determination.

(1c) The obstacle detection device 1 executes the processing of the type determination process and the position determination process on only cells in which the detection probability P is nonzero, thus reducing the amount of processing compared with processing executed on all cells.

(1d) The obstacle detection device 1 determines the vertical position of the target based on the trend in detection probabilities P varying with changes in the relative position between the environment monitoring sensor 2 and the small target. This enables the subsequent processing that uses this determination result to deal with the small target properly.

### 1-4. Modification

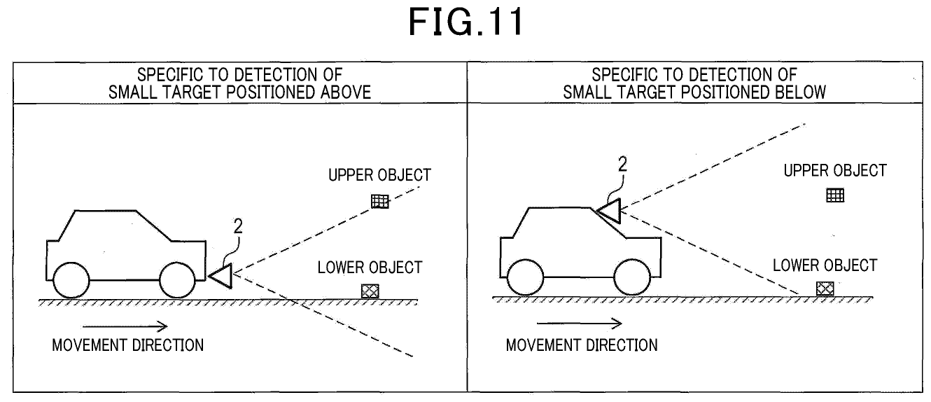

In the above embodiment, the environment monitoring sensor 2 is installed in or near the front bumper as an example. However, the installation position of the environment monitoring sensor 2 may be changed in accordance with the vertical position of a small target to be detected. Specifically, as shown in FIG. 11, to detect a small target positioned above, the environment monitoring sensor 2 may be installed at a position as close to the road surface as possible. This positioning can increase the rate of change ΔP of detection probabilities P of a small target positioned above. In contrast, to detect a small target positioned below such as a fallen object on the road surface, the environment monitoring sensor 2 may be installed at a position as far from the road surface as possible, for example, near the rearview mirror. This positioning can increase the rate of change ΔP of detection probabilities P of a small target positioned below.

### 2. Second Embodiment

### 2-1. Differences from First Embodiment

A second embodiment is basically similar to the first embodiment, and thus differences will now be described. It is noted that the same reference numerals as in the first embodiment represent the same components and refer to the preceding description.

In the first embodiment described above, the environment monitoring sensor 2 is described as a single component. However, the second embodiment is different from the first embodiment in that a plurality of environment monitoring sensors 2 are installed at different heights.

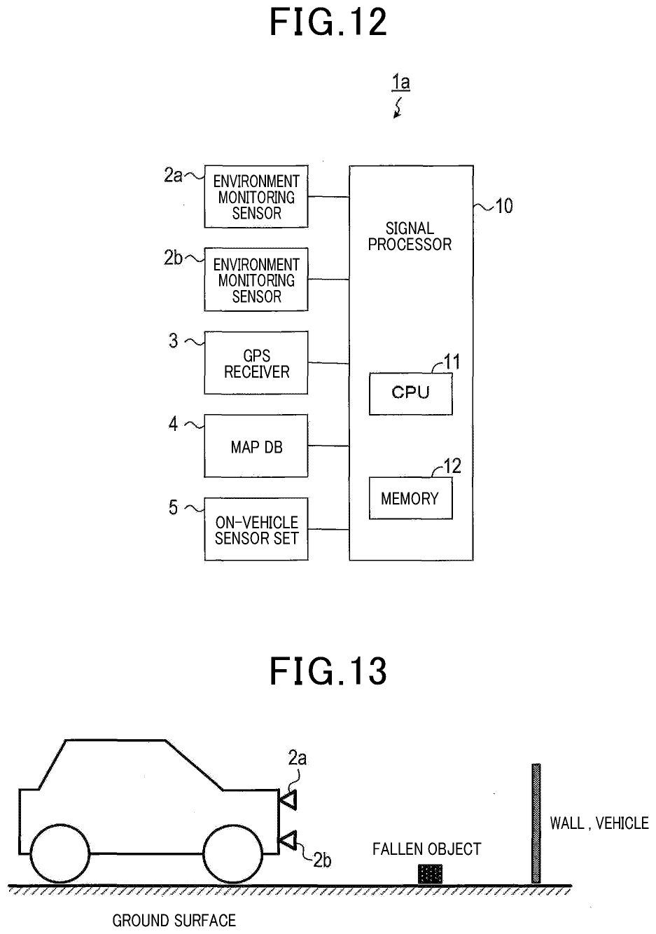

As shown in FIG. 12, an obstacle detection device 1a according to the present embodiment includes two environment monitoring sensors 2a and 2b.

As shown in FIG. 13, the two environment monitoring sensors 2a and 2b are arranged at the same position on a horizontal plane but at different vertical positions.

### 2-2. Processing

The processing of each process executed by the signal processor 10 will now be described focusing on differences from the first embodiment.

### [2-2-1. Grid Map Update Process]

This grid map update process is the same as the grid map update process in the first embodiment described with reference to FIG. 3, except that the processing is executed for each of the two environment monitoring sensors (hereinafter simply the sensors) 2a and 2b.

### [2-2-2. Obstacle Detection Process]

This obstacle detection process is different in the processing of S220 and S230 from the obstacle detection process in the first embodiment described with reference to FIG. 6.

Specifically, in S220, the signal processor 10 calculates and records a detection probability P regarding the subject cell for each of the sensors 2a and 2b.

In S230, the signal processor 10 provides an affirmative determination result if the detection probability P regarding the subject cell is greater than 0 for each of the sensors 2a and 2b, and a negative determination result if the detection probability P for at least one is equal to 0.

### [2-2-3. Type Determination Process]

This type determination process is different in the processing of S310 and S350 from the type determination process in the first embodiment described with reference to FIG. 7.

Specifically, in S310, the signal processor 10 provides an affirmative determination result if the detection probability P regarding the subject cell is greater than TH1 for each of the sensors 2a and 2b, and a negative determination result if the detection probability P for at least one is smaller than or equal to TH1.

In S350, the signal processor 10 provides an affirmative determination result if the detection probability P regarding the subject cell is greater than TH2 for at least one of the sensors 2a and 2b, and a negative determination result if the detection probability P for both is smaller than or equal to TH2.

### [2-2-4. Position Determination Process]

The following describes the principle of the processing of the position determination process executed by the signal processor 10 in place of the position determination process in the first embodiment described with reference to FIG. 9.

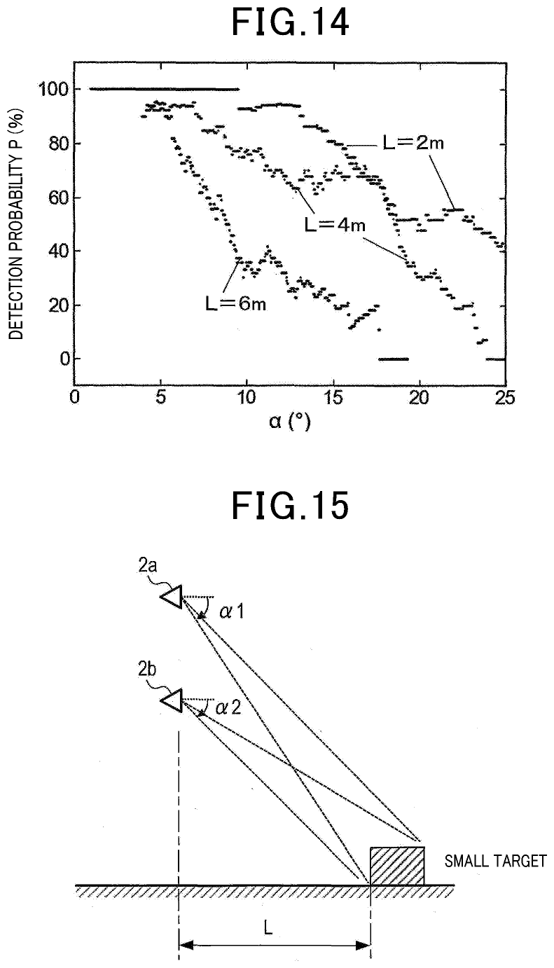

FIG. 14 is a graph showing the results of measurements of detection probabilities P of a small target with constant horizontal distances L between the sensors 2a and 2b and the small target, and varying angles α at which the small target is viewed from the front of the sensors 2a and 2b (i.e., the vertical positions of the sensors 2a and 2b). Note that the measurements were conducted at horizontal distances L of 2 m, 4 m, and 6 m.

FIG. 15 shows a horizontal distance L and angles α1 and α2. The angle α1 is an angle for the sensor 2a, while the angle α2 is an angle for the sensor 2b. However, a small object viewed from the sensors has variations in angle, and thus the angles α1 and α2 vary in accordance with the variations.

As shown in FIG. 14, with a constant horizontal distance L, as the emission angle α increases, or in other words, as the sensor position becomes higher, the detection probability P of a small target tends to decrease. With a constant emission angle α, as the horizontal distance L increases, or in other words, as the sensor position becomes higher, the detection probability P of a small target tends to decrease.

Thus, with a translation table prepared in advance that represents the relationship shown in FIG. 14 between detection probabilities P and angles α indicating directions in which a target is visible, the direction in which the target lies can be estimated from the detection probability P by referring to the translation table. Although the measurements are nonlinear, the results from the plurality of sensors 2a and 2b at different vertical positions can be combined to increase the accuracy of estimation. It is noted that the translation table is prestored in the memory 12. The translation table corresponds to association information.

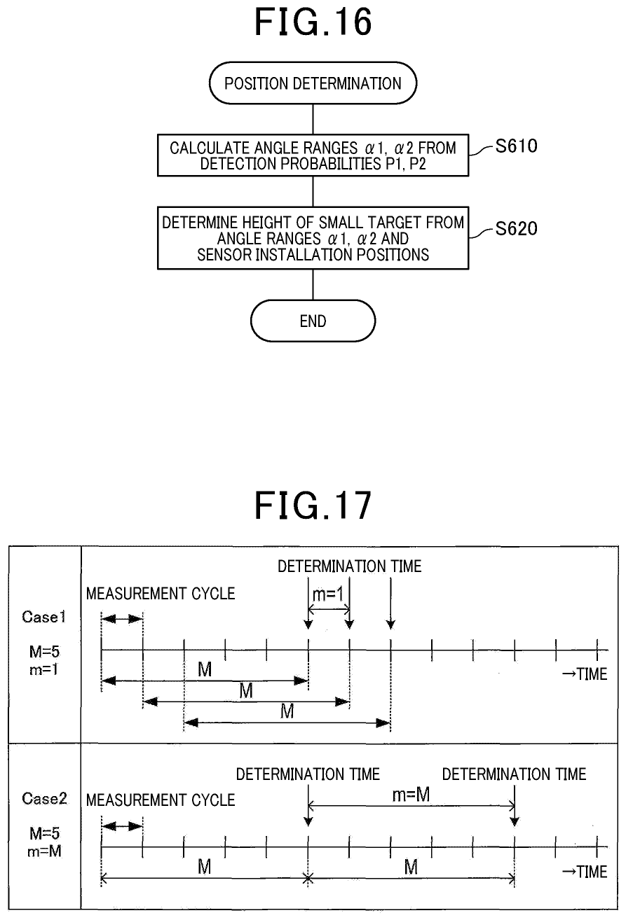

The position determination process in the present embodiment will now be described with reference to the flowchart shown in FIG. 16.

In S610, the signal processor 10 uses the translation table to determine the angles α1 and α2 from detection probabilities P1 and P2 for the subject cell calculated respectively in the two sensors 2a and 2b.

Subsequently in S620, the signal processor 10 determines the position of the top of the small target, that is, the height of the small target using the installation positions of the sensors 2a and 2b and the angles α1 and α2 determined in S610. The signal processor 10 outputs the determination result and ends the process. The determination result may be represented by a specific numerical value or, for example, whether the height can be driven over or cannot be driven over by the vehicle. The installation positions of the sensors 2a and 2b may be represented by the gap between the sensors 2a and 2b and the average height of the sensors 2a and 2b from the road surface. When the horizontal distance L is much (e.g., twice or more times) greater than the installation heights of the sensors 2a and 2b, the difference in translation properties made by the gap between the sensors 2a and 2b is negligible.

### 2-3. Effects

According to the second embodiment described in detail above, the effects (1a) to (1c) of the above first embodiment are achieved, and the following effect is also achieved.

(2a) Even if a weak signal strength makes it difficult to determine when the reflected waves are received and thus detect the distance to the target with high accuracy, the obstacle detection device 1a can use the detection probability P to determine the height of the small target.

### 3. Other Embodiments

Although embodiments of the present disclosure have been described, the present disclosure is not limited to the above embodiments but may be modified variously.

(3a) In the embodiments described above, the thresholds TH1 to TH3 are used for determination in the type determination process and the position determination process. However, the present disclosure is not limited to this example. For example, likelihoods may be calculated and used for determination.

(3b) In the embodiments described above, the distance rate of change is used as the rate of change ΔP of detection probabilities in the position determination process. However, the time rate of change may be used.

(3c) In the second embodiment described above, the two environment monitoring sensors 2a and 2b are used. However, three or more sensors may be used.

(3d) The signal processor 10 and the technique thereof described in the present disclosure may be implemented by a special purpose computer including memory and a processor programmed to execute one or more functions embodied by computer programs. Alternatively, the signal processor 10 and the technique thereof described in the present disclosure may be implemented by a special purpose computer including a processor formed of one or more dedicated hardware logic circuits. Alternatively, the signal processor 10 and the technique thereof described in the present disclosure may be implemented by one or more special purpose computers including a combination of memory and a processor programmed to execute one or more functions and a processor formed of one or more hardware logic circuits. The computer programs may be stored in a non-transitory, tangible computer readable storage medium as instructions to be executed by a computer. The technique for implementing the functions of the components included in the signal processor 10 may not necessarily include software, and all the functions may be implemented by one or more pieces of hardware.

(3e) A plurality of functions of one component in the embodiments described above may be implemented by a plurality of components, or one function of one component may be implemented by a plurality of components. A plurality of functions of a plurality of components may be implemented by one component, or one function implemented by a plurality of components may be implemented by one component. Some components in the embodiments described above may be omitted. At least some components in one of the embodiments described above may be added to or substituted for components in another of the embodiments described above.

(3f) In addition to the obstacle detection device and the obstacle detection method described above, the present disclosure may be implemented in a variety of forms such as a system including the obstacle detection device as a component, a program that allows a computer to function as the obstacle detection device, and a non-transitory tangible storage medium such as a semiconductor memory storing the program.

### CONCLUSION

One aspect of the present disclosure is directed to providing a technique for improving the accuracy of detecting a small target.

An aspect of the present disclosure provides an obstacle detection device including a result acquisition unit, a probability calculation unit, and a type determination unit. The result acquisition unit is configured to repeatedly acquire measurement results from an environment monitoring sensor that emits probe waves to a predetermined probe region and measures the distance and the direction to a reflection point at which the probe waves are reflected. The probability calculation unit is configured to calculate a detection probability for each reflection point in accordance with the measurement results acquired by the result acquisition unit. The type determination unit is configured to determine the type of the target having the reflection point in accordance with the detection probability calculated by the probability calculation unit.

An aspect of the present disclosure provides an obstacle detection method implemented by a computer. The computer repeatedly acquires measurement results from an environment monitoring sensor that emits probe waves to a predetermined probe region and measures the distance and the direction to a reflection point at which the probe waves are reflected. The computer calculates a detection probability for each reflection point in accordance with the acquired measurement results. The computer determines the type of the target having the reflection point in accordance with the calculated detection probability.

According to these aspects, the type of a target is determined not by reflection strength, which is affected greatly by the environment, but by a detection probability representing the characteristics of a small target that are difficulty in detection. Thus, the obstacle detection device and the obstacle detection method can improve the accuracy of detecting a small target that is difficult to track because of intermittent detection of reflection points.

What is claimed is:

1. An obstacle detection device comprising:
a result acquisition unit configured to repeatedly acquire a measurement result from an environment monitoring sensor that emits probe waves to a predetermined probe region and measures a distance and a horizontal direction to a reflection point at which the probe waves are reflected;
a probability calculation unit configured to calculate a detection probability for each reflection point in accordance with the measurement result acquired by the result acquisition unit; and
a type determination unit configured to determine a type of a target having the reflection point in accordance with the detection probability calculated by the probability calculation unit, wherein
the type determination unit refers to a first threshold and a second threshold set at a value greater than the first threshold, and determines a type as a normal target when the detection probability is greater than the second threshold, as a small target smaller than the normal target in vertical size when the detection probability is smaller than or equal to the second threshold and greater than the first threshold, and as a virtual image when the detection probability is smaller than or equal to the first threshold.

2. The obstacle detection device according to claim 1, wherein
the probability calculation unit calculates the detection probability for individual cells defined by a grid dividing a region represented in a predetermined absolute coordinate system.

3. The obstacle detection device according to claim 2, further comprising
a position acquisition unit configured to acquire a position and an orientation of a device-equipped vehicle in the absolute coordinate system,
wherein the probability calculation unit calculates the detection probability for each cell associated with the probe region based on information acquired by the position acquisition unit and the probe region.

4. The obstacle detection device according to claim 1, further comprising:
a change rate calculation unit configured to calculate a rate of change of the detection probability for the reflection point determined as the small target by the type determination unit; and
a height determination unit configured to determine a vertical position of the small target in accordance with the rate of change of the detection probability calculated by the change rate calculation unit.

5. The obstacle detection device according to claim 1, wherein
the result acquisition unit acquires the measurement results from a plurality of the environment monitoring sensors installed at different heights,
the probability calculation unit calculates the detection probability at each of the plurality of environment monitoring sensors, and
the obstacle detection device further comprises a height determination unit configured to determine a height of the small target based on installation positions of the plurality of environment monitoring sensors and association information indicating a relationship between the detection probabilities calculated at the plurality of environment monitoring sensors for the same reflection point and a direction to the reflection point.

6. An obstacle detection method implemented by a computer, the method comprising:
repeatedly acquiring a measurement result from an environment monitoring sensor that emits probe waves to a predetermined probe region and measures a distance and a horizontal direction to a reflection point at which the probe waves are reflected;
calculating a detection probability for each reflection point in accordance with the acquired measurement result;
referring to a first threshold and a second threshold set at a value greater than the first threshold; and
determining a type of a target having the reflection point as a normal target when the detection probability is greater than the second threshold, as a small target smaller than the normal target in vertical size when the detection probability is smaller than or equal to the second threshold and greater than the first threshold, and as a virtual image when the detection probability is smaller than or equal to the first threshold.
